(19) United States
(12) Patent Application Publication
(10) Pub. No.: US 2006/0173814 A1
(43) Pub. Date: Aug. 3, 2006

(54) Mobile communication terminal having content-based retrieval function

(75) Inventor: Han-Seung Jung, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/344,977

(22) Filed: Feb. 1, 2006

(30) Foreign Application Priority Data
Feb. 2, 2005 (KR) 2005-0009420

(51) Int. Cl. G06F 17/30

(52) U.S. Cl. 707/2

(57) ABSTRACT

Disclosed is an apparatus and a method for providing a content-based retrieval function using a mobile communication terminal, the apparatus including a transmitter/receiver for communicating with a data server capable of content-based retrieval and a controller for controlling a transmission of a query to the data server via the transmitter/receiver in a multimedia transmission scheme and a reception of a query result from the data server via the transmitter/receiver.

### PRIORITY

This application claims priority under 35 U.S.C. § 119 to an application entitled “Mobile Communication Terminal Having Content-Based Retrieval Function” filed in the Korean Intellectual Property Office on Feb. 2, 2005 and assigned Serial No. 2005-9420, the contents of which are incorporated herein by reference.

### BACKGROUND OF THE INVENTION

1. Field of the Invention

The present invention relates generally to a mobile communication terminal having a content-based retrieval function, and in particular, to a mobile communication terminal having a content-based retrieval function in which a transmitter/receiver communicates with a data server capable of content-based retrieval and a controller controls transmission of a query to the data server through the transmitter/receiver in a multimedia transmission scheme and reception of query results from the data server through the transmitter/receiver.

2. Description of the Related Art

As the multimedia technologies evolve, increasing amounts of multimedia data must be serviced in various fields. Traditionally, text indexing and content-based indexing are used for the retrieval of multimedia data. Text indexing is the process of indexing the text features of multimedia data into a database for retrieval using an input keyword. Unfortunately the text indexing method has several drawbacks including a drawback caused by inefficient extraction of features. Moreover, the text indexing method is known for frequently returning incorrect query results when querying multimedia data which is at least in part due to limitations inherent to using a text-based query.

Recently, content-based indexing was proposed to tackle the problems inherent to text indexing. An example of context-based indexing is disclosed in “Review of Image and Video Indexing Techniques”, F. Idris and S. Panchanathan, Journal of Visual Communication and Image Representation, Vol. 8, No. 2, pp. 146-166, June 1997, which is referred to herein. Another example of content-based indexing is an industry standard known as the Moving Picture Experts Group (MPEG)-7 standard. MPEG-7 provides a description of multimedia content and content-based searching and is designed to assist content-based access to multimedia data. MPEG-7 specifies a standard set of descriptors and description schemes being sets of descriptors. The MPEG-7 descriptors, usually taking the form of feature vectors, describe audio-visual features of multimedia data, such as spatial relationships, color, texture, shape, object motion, sound, pitch and spectral features.

At present, mobile communication terminals use text indexing and retrieval using a Wireless Application Protocol (WAP) for performing a data search in a data server, and therefore suffer from the limitations and disadvantages of text indexing retrieval methods.

### SUMMARY OF THE INVENTION

Accordingly, it is object of the present invention to substantially solve at least the above problems and/or disadvantages and to provide at least the advantages described below.

Accordingly, it is an object of the present invention to provide a mobile communication terminal capable of performing a content-based retrieval and a content-based retrieval method for transmitting a query directly to a data server and retrieving data from the data server by using a Multimedia Messaging Service (MMS) without using a Wireless Application Protocol (WAP).

It is, another object of the present invention to provide a mobile communication terminal capable of performing content-based retrieval and a content-based retrieval method for retrieving multimedia information by transmitting to a search engine a text query, an audio query and a video query either alone or in combination with each other, thereby facilitating data retrieval and downloading.

The above objects are achieved by providing a mobile communication terminal having a content-based retrieval function and a content-based retrieval method.

According to one aspect of the present invention, in a mobile communication terminal having a content-based retrieval function, a transmitter/receiver communicates with a data server capable of content-based retrieval and a controller controls transmission of a query to the data server via the transmitter/receiver in a multimedia transmission scheme and reception of a query result from the data server via the transmitter/receiver.

According to another aspect of the present invention, in a content-based retrieval method in a mobile communication terminal, a query is formed and transmitted to a data server. A query result list is received from the data server.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile communication terminal and a data server according to an embodiment of the present invention; and

FIG. 2 is a flowchart illustrating for a method for performing a content-based retrieval and data downloading according to an embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

In accordance with the present invention, a message sent to a data server for retrieval of multimedia data can transfer multimedia content. While this message can be any message supporting a Multipurpose Internet Mail Extension (MIME) protocol, the present invention will be described in the context of an Multimedia Messaging Service (MMS) message.

The MIME is an extension of a Simple Mail Transfer Protocol (SMTP) that enables the transmission of non-ASCII multimedia data including text, pictures, voice and images in e-mails over the Internet without conversion to an ASCII format.

The terms used herein will be briefly defined. “Multimedia data” can include pictures, images (such as still and moving), music, tunes, melodies, sounds such as a humming) and combinations thereof, A “humming” can include a music file (e.g., containing a tune, etc.) created by vocalization without opening the mouth. Furthermore, as used herein a “query” is a command which is used to search a database for desired data that most closely satisfies a users request. In other words, a query defines a data range to be searched in a database.

The present invention is intended to provide a mobile communication terminal capable of performing a content-based retrieval. The mobile communication terminal is characterized in that it relies on the MMS without using the WAP in sending a query to a data server and receives query results from the data server in a content-based retrieval. The query can be a text query, a picture query, a sound query, an image query and a music query, either alone or in any combination thereof.

The MMS is a messaging service for mobile communication terminals, which enables the transfer of multimedia data including pictures, images, sounds and music.

In addition, when searching for a desired song on a content basis, a user of a mobile communication terminal can form a query to find the desired song by sending to a data server the query. The query can include multimedia data such a sound (e.g., a humming), a song, a tune, a melody, a picture, an image, a written passage or spoken passage (e.g., a title of the song, a composer and/or singer's name, etc.) and combinations thereof.

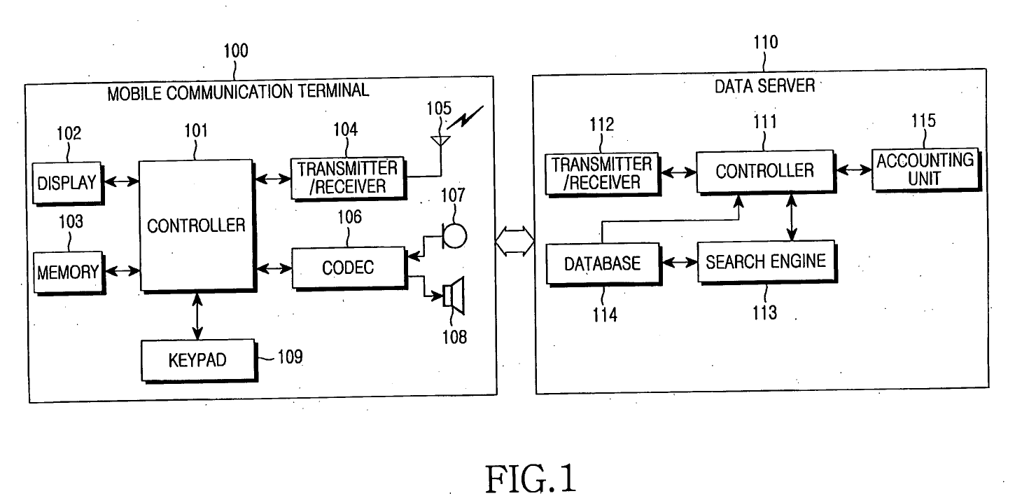

A content-based retrieval apparatus according to the present invention will be described below with reference to FIG. 1, which is a block diagram of a mobile communication terminal and a data server according to an embodiment of the present invention.

Referring to FIG. 1, the content-based retrieval apparatus includes a mobile communication terminal 100 and a data server 110. The mobile communication terminal 100 includes a controller 101, a display 102, a memory 103, a transmitter/receiver 104, an antenna 105, a CODEC 106, a microphone 107, a speaker 108 and a keypad 109.

The controller 101 controls the overall operation of the mobile communication terminal 100. For example, the controller 101 processes and controls voice and data communications. In addition to the basic functionality, the controller 101 controls an operation for forming and sending a query for content-based retrieval of multimedia data and for downloading desired data according to the present invention. Herein, the sake of clarity, a description of the typical process and control of the controller 101 is not provided.

The display 102 displays state information (or indicators) generated during the operation of the mobile communication terminal 100. For example, the display displays characters, digits, moving pictures and still images. The display 102 can include a liquid crystal display (LCD) or other display medium.

The memory 103 stores programs for controlling the overall operation of the mobile communication terminal 100, temporarily stores data generated during the operation of the mobile communication terminal 100 and stores data for later retrieval such as phone numbers, Short Message Service (SMS) messages, image data, etc.

The transmitter/receiver 104 is a module for transmitting/receiving a frequency signal for communications between the mobile communication terminal 100 and the data server 110. For example, the transmitter/receiver 104 channel-encodes and spreads transmission data for transmission, and despreads and channel-decodes a received signal for reception.

The CODEC 106 converts pulse code modulation (PCM) data received from the controller 101 to an analog voice signal and outputs the analog voice signal through the speaker 108. It also converts a voice signal received through the microphone 107 to PCM data and provides the PCM data to the controller 101.

The keypad 109 has digit keys (e.g., numerals 0 to 9) and function keys such as a MENU key, a Cancel (Clear) key, an OK key, a Talk key, an End key, an Internet key, and navigation keys (e.g., ▴/▾/ [symbol] / [symbol] ). The keypad 109 provides key input data corresponding to a key pressed by the user.

The data server 110 includes a controller 111, a transmitter/receiver 112, a data base 114, a search engine 113 and an accounting unit 115. The controller 111, is used for searching a database 114 using the search engine 113 with respect to a query received from the mobile communication terminal 100. Moreover, if downloading of detected data desired, the controller includes functionality for calculating a charge for providing the data through an accounting unit 115.

The transmitter/receiver 112 is used for receiving the query from the mobile communication terminal 100. The search engine 113 is used for performing a text-based search or a content-based search with respect to the query. The database 114 is used for storing multimedia data. The accounting unit 115 is used for calculating the charge of detected (and/or selected) data and informing the controller 111 of the charge if the user desires to download the detected and/or selected data.

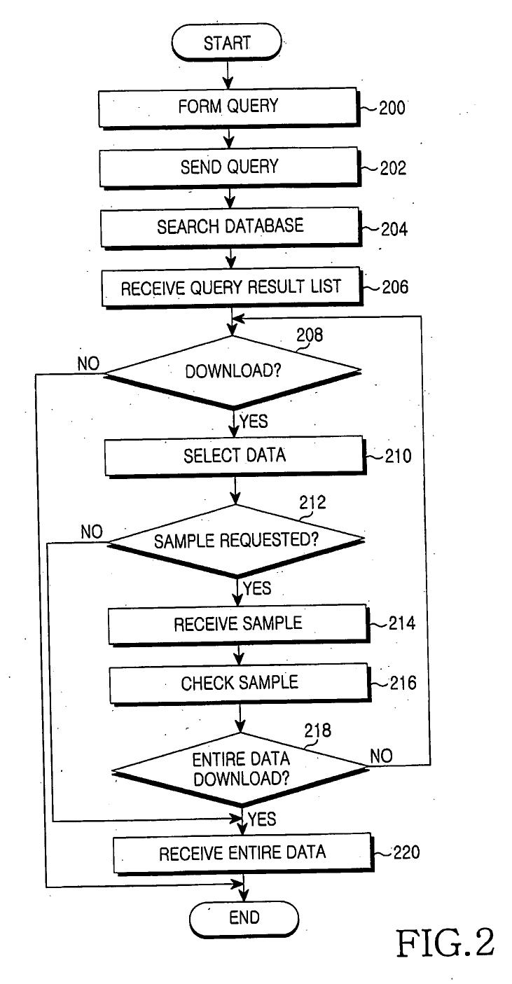

FIG. 2 is a flowchart illustrating for a method for performing a content-based retrieval and data downloading according to an embodiment of the present invention.

Referring to FIG. 2, the user of the mobile communication terminal forms a query in step 200. The query includes at least one of a text query, a picture query, a sound query and a music query. In step 202, the query is sent to the data server 110 using the MMS. A text-based search or a content-based search is performed for the query and query results are generated in step 204. The mobile communication terminal 100 receives from the data server 110 a list of the query results in step 206.

In step 208 it is determined whether the user desires to download content of the query results.

If it is determined that the a download the content of query results is not requested in step 208, the procedure ends.

On the other hand, if it is determined that a download the content of the query results, is requested in step 208, the data to be received among the content of query results is selected in step 210. In step 212, if a particular sample is not selected within a predetermined time period in step 212, the procedure proceeds to step 220 in which the user receives all the content corresponding to the query results and thereafter the procedure ends.

On the other hand, if the user selects a particular data sample in step 212, the sample is transmitted by the data server 110 to the mobile communication terminal 100 using the MMS in step 214 and the mobile communication terminal displays or plays the received sample in step 216. In step 218, it is determined whether the user desires to receive the entire data corresponding to the sample in step 218. In step 218, if it is determined that the user desires to receive the entire data corresponding the received sample, the corresponding data is transmitted to the mobile communication terminal in step 220.

On the other hand, if the user does not want to receive the entire data in step 218, the procedure returns to step 208.

The MMS service transfers messages using MMS protocol data units (PDUs) including M-Send.req, M-Notification.ind, Get-req, and M-Retrieve.conf according to the MMS standard defined by the Open Mobile Alliance (OMA).

The fields of each MMS PDU are configured in compliance with the MMS standard. For further detail, see “Enabler Release Definition for MMS Version 1.2”, OMA-ERELD-MMS-v1.2, “Multimedia Messaging Service Architecture Overview Version 1.2”, OMA-MMS-ARCH-v1.2”, “MMS Conformance Document Version 2.0.0”, OMA-IOP-MMSCONF-v1.2, “MMS Client Transactions Version 1.2”, OMA-WAP-MMS-CTR-v1.2, “OMA MMS Encapsulation Protocol Version 1.2”, OMA-WAP-MMS-ENC-v.12 and “WAP Wireless Session Protocol Specification”, WAP-203-WSP-20020920-C.

According to the present invention, the mobile communication terminal communicates with the data server using MMS PDUs, for content-based retrieval, which will be described hereinbelow.

The mobile communication terminal sends a query to the data server using an “M-Send.req” message. The query, including at least one of an image, a sound and a picture, etc. is set in a “Content field” of the “M-Send.req” message. In the case of following the MMS standard specification, the data server determines that the query requires a content-based retrieval by recognizing information set in a “To field” of the M-Send.req” message. For example, this information can be the address of the data server. Alternatively, the data server can determine that the query requires a content-based retrieval by recognizing a corresponding field based on Hyper Text Transfer Protocol (HTTP) or an MMS stack optionally added in an M-Send.req.message.

The data server sends the query results to the mobile communication terminal “M-Notification.ind” message. In the case of following the MMS standard specification, the mobile communication terminal determines that the received message includes query results by checking information set in a “From field” of the “M-Notification.ind” message, or in a corresponding field based on an HTTP or an optional MMS stack included in the “M-Notification.ind” message.

If the “M-Notification” message includes a single query result, a Subject field of the “M-Notification.ind” message includes a query result list and an “X-MMS-content-Location” field thereof includes a Uniform Resource Identifier (URI) from which the whole or a part of the query result can be received. In addition, a corresponding field based on HHTP or the MMS stack can be added to M-Notification.ind message.

If the “M-Notification.ind” message includes a plurality of query results, a new field is added to M-Notification.ind message. This new field includes a list of the query results and one or more URIs from which the whole or part of each of the corresponding query results can be received.

The mobile communication terminal selects a desired query result in the query result list and requests the whole or part of the selected query result to the data server using the “GET.req” message.

If the mobile communication terminal requests a plurality of query results using the “GET.req”, message a new field is added to “GET.req” message. This new field includes a list of the requested query results and corresponding URIs from which the whole or part of the query results can be received.

The data server sends the whole or part of each of the requested query results to the mobile communication terminal using the “M-Retrieve.conf” message.

As described above, a mobile communication terminal having a content-based retrieval function according to the present invention does not limit a search to text when searching for multimedia information. The search can be performed by sending a text query, an audio query, and a video query, etc. alone or in combination thereof to a search engine. Therefore, content-based data retrieval and downloading is facilitated and a user can search data in various ways.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A mobile communication terminal comprising:
a transmitter/receiver for communicating with a data server capable of performing a content-based retrieval; and
a controller for controlling transmission of a query to the data server via the transmitter/receiver using a multimedia transmission scheme and for controlling reception of a query result from the data server via the transmitter/receiver.

2. The mobile communication terminal of claim 1, wherein the multimedia transmission scheme uses a Multimedia Messaging Service.

3. The mobile communication terminal of claim 1, further comprising a microphone for generating an audio file generated by inputting an audible sound.

4. The mobile communication terminal of claim 1, wherein the query includes at least one of text data and multimedia data.

5. The mobile communication terminal of claim 1, wherein the controller selects at least one of a plurality of query results;
requests the selected query result to the data server, and
receives data corresponding to the requested query result.

6. The mobile communication terminal of claim 1, wherein the controller:
selects at least one of a plurality of received query results;
requests sample data corresponding to the selected query result to the data server;
receives the sample data corresponding to the selected query result; and
receives the whole data of the query result from the data server.

7. A data server capable of content-based retrieval, comprising:
a transmitter/receiver for communicating with a mobile communication terminal;
a database for storing and managing multimedia data;
a search engine for performing at least one of a text-based search and a content-based search corresponding to a query received from the mobile communication terminal; and
a controller for:
receiving the query from the mobile communication terminal through the transmitter/receiver;
forming a list of query results through the database and the search engine;
transmitting the list of query results to the mobile communication terminal through the transmitter/receiver; and
transmitting sample data or whole data corresponding to the list of query results to the mobile communication terminal through the transmitter/receiver, if the mobile communication terminal requests sample data or whole data corresponding to the query results.

8. The data server of claim 7, further comprising an accounting unit for calculating a charge for at least one of the list of query results, the sample data, and whole data, when the data server transmits at least one of the list of query results, the sample data and the whole data.

9. A content-based retrieval method in a mobile communication terminal, comprising the steps of:
forming a query;
transmitting the query to a data server; and
receiving a list of query results from the data server.

10. The content-based retrieval method of claim 9, wherein the transmitting step comprises transmitting the query to the data server using a “To field” or an additional field of an “M-Send.req” message using a Multimedia Messaging Service (MMS) message, the additional field being configured based on a Hyper Text Transfer Protocol (HTTP) or an MMS stack.

11. The content-based retrieval method of claim 9, wherein the receiving step comprises receiving the list of query results from the data server in a “From field” or in an additional field of an “M-Notification.ind” message, the “M-Notification.ind” message being a Multimedia Messaging Service (MMS) message, the additional field being configured based on a Hyper Text Transfer Protocol (HTTP) or an MMS stack.

12. The content-based retrieval method of claim 9, wherein if the list of query results includes a plurality of query results, an “M-Notification.ind” message includes an additional field including Uniform Resource Identifiers (URIs) corresponding to the respective query results.

13. The content-based retrieval method of claim 9, further comprising generating a music file by recording a singing or a humming corresponding to a song or a tune, if the query is a music query.

14. The content-based retrieval method of claim 9, wherein the query includes at least one of text data and multimedia data.

15. A content-based retrieval method in a mobile communication terminal, comprising the steps of:
forming a query;
transmitting the query to a data server;
receiving a list of query results from the data server;
selecting a query result from the list of query results and requesting the selected query result to the data server; and
receiving the requested query result from the data server.

16. The content-based retrieval method of claim 15, wherein the transmitting step comprises transmitting the query to the data server in a “To field” or in an additional field of an “M-Send.req” message, the “M-Send.req” message being a Multimedia Messaging Service (MMS) message, the additional field being configured based on a Hyper Text Transfer Protocol (HTTP) or an MMS stack.

17. The content-based retrieval method of claim 15, wherein the step of receiving the list of query results comprises receiving the query result from the data server in a “From field” or in an additional field of an “M-Notification.ind” message, the “M-Notification.ind” message being an Multimedia Messaging Service (MMS) message, the additional being configured based on Hyper Text Transfer Protocol (HTTP) or an MMS stack.

18. The content-based retrieval method of claim 15, wherein if the list of query results includes a plurality of query results, an M-Notification.ind message includes an additional field including Uniform Resource Identifiers (URIs) corresponding to the respective query results.

19. The content-based retrieval method of claim 15, wherein the step of requesting the selected query result comprises requesting the selected query result to the data server by using a “GET.req” message the GET.req being a Multimedia Messaging Service (MMS) message and including an additional field with the selected query result and a Uniform Resource Identifier (URI) corresponding to the selected query result.

20. The content-based retrieval method of claim 15, wherein the step of receiving the requested query result comprises receiving the requested query result from the data server using an “M-Retrieve.conf” being a Multimedia Messaging Service (MMS) message.

21. The content-based retrieval method of claim 15, further comprising receiving sample data of the selected query result and determining whether to receive the whole data of the selected query result, before requesting the selected query result.

22. A content-based retrieval method in a data server, comprising the steps of:
receiving a query from a mobile communication terminal;
performing a text-based search or a content-based search with respect to the received query using a search engine;
forming a list of query results;
transmitting the query result list to the mobile communication terminal;
receiving from the mobile communication terminal a message requesting a selected query result; and
transmitting sample data or whole data of the selected query result to the mobile communication terminal.

23. The content-based retrieval method of claim 22, further comprising calculating a charge of at least one of the query result list, the sample data and the whole data corresponding to the selected query result, when the data server transmits at least one of the query result list, the sample data and the whole data corresponding to the selected query result.
